(19) United States
(12) Patent Application Publication
(10) Pub. No.: US 2025/0161726 A1
(43) Pub. Date: May 22, 2025

(54) MULTIFUNCTIONAL CONNECTOR RING

(71) Applicant: YOKE INDUSTRIAL CORP., Taichung City (TW)

(72) Inventor: WEI-CHIEH HUNG, Taichung City (TW)

(73) Assignee: YOKE INDUSTRIAL CORP., Taichung City (TW)

(21) Appl. No.: 18/436,047

(22) Filed: Feb. 8, 2024

(30) Foreign Application Priority Data
Nov. 16, 2023 (TW) 112144267

(51) Int. Cl. A62B 35/00

(52) U.S. Cl. CPC A62B 35/0075

(57) ABSTRACT

A multifunctional connector ring has a ring body, wherein the ring body has a hanging hole, two webbing holes and two rope holes; the two rope holes are located between the hanging hole and the two webbing holes; each of the webbing holes has a first long edge, a second long edge, and two short edges connected between the first long edge and the second long edge, wherein a sliding groove is formed by the two short edges of one of the webbing holes respectively; a sliding rod is disposed between the two sliding grooves; the sliding rod has two end portions; each of the sliding grooves is reached in by the two end portions respectively; the sliding rod is slid back and forth along the two short edges, so that the hanging hole is adapted to buckle a buckle; each of the rope holes and each of the webbing holes are adapted to thread ropes and webbings; one of the webbings fits around the sliding rod and is fixed by a clamping of the sliding rod and the first long edge, thereby achieving an effect of a length being fixed of the webbing without another buckle.

### BACKGROUND OF THE INVENTION

### Technical Field

The present invention relates generally to a safety connector for climbing operations, and more particularly to a multifunctional connector ring.

### Description of Related Art

An existing connector ring generally has only one function. For example, a rope ring is adapted to be passed by a rope, a webbing ring is adapted to be passed by a webbing, and a ring body provided for hanging an accessory is adapted to hang the accessory or a fastener.

When the existing connector ring is typically passed by a webbing, the existing connector ring is only adapted to support the webbing and change an extending direction of the webbing. When a length of the webbing is required to be fixed, the length of the webbing that extends is adjusted by clamping the webbing with a fastener that fixes the webbing. As a result, the existing connector ring that are adapted to be passed through by a rope or a webbing is limited in use and could not provide a multifunctional effect. Moreover, the existing connector ring needs to work with a fastener in order to fix the webbing, which causes more inconveniences in use.

### BRIEF SUMMARY OF THE INVENTION

In view of the above, the primary objective of the present invention is to provide a connector ring, which has holes for hanging and being passed by a rope and a webbing and is adapted to fix the webbing, thereby providing users with a multifunctional effect and being convenient for users to widely apply to various situations such as mountain climbing, tree climbing, operations at heights, safety belt setting, etc.

The present invention provides a multifunctional connector ring, including a ring body and a sliding rod; the ring body has a hanging hole, two webbing holes, and two rope holes; the two rope holes are located between the hanging hole and the two webbing holes, wherein a periphery of each of the two webbing holes has a first long edge, a second long edge, and two short edges connected between the first long edge and the second long edge; the two short edges of one of the two webbing holes have a sliding groove respectively; the sliding rod has two end portions, wherein the two end portions are respectively inserted into the two sliding grooves, so that the sliding rod is slidable toward the first long edge of the webbing hole provided with the two sliding grooves or toward the second long edge of the webbing hole provided with the two sliding grooves.

When the present invention is used, the hanging hole is adapted to hang a hook or an accessory, the two rope holes and the two webbing holes are adapted to be passed by ropes and webbings, so that the present invention has a multifunctional effect. Furthermore, after the free end of the webbing passes between the sliding rod and the second long edge of one of the webbing holes that is provided with the sliding rod, the webbing is folded backward and the free end of the webbing reversely passes between the sliding rod and the first long edge of the webbing hole; then the free end of the webbing is tightly pulled outward and the webbing surrounds the sliding rod and is pulled toward the first long edge of the webbing hole, so that the webbing is fixed and clamped by the sliding rod and the first long edge of the webbing hole, thereby achieving an effect of fixing the length of the webbing without requiring another fastener and being convenient for users to utilize.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the connector ring according to an embodiment of the present invention;

FIG. 2 is a side view of the connector ring according to the embodiment of the present invention;

FIG. 3 is a sectional view along the 3-3 line in FIG. 2;

FIG. 4 is a top view of the connector ring according to the embodiment of the present invention;

FIG. 5 is a sectional view along the 5-5 line in FIG. 4;

FIG. 6 is a sectional view along the 6-6 line in FIG. 4;

FIG. 7 is a schematic view, showing the connector ring according to the embodiment of the present invention is passed by the rope and the webbing; and

FIG. 8 is a schematic sectional view of the connector ring according to the embodiment of the present invention, showing the webbing passes through the connector ring and is fixed.

### DETAILED DESCRIPTION OF THE INVENTION

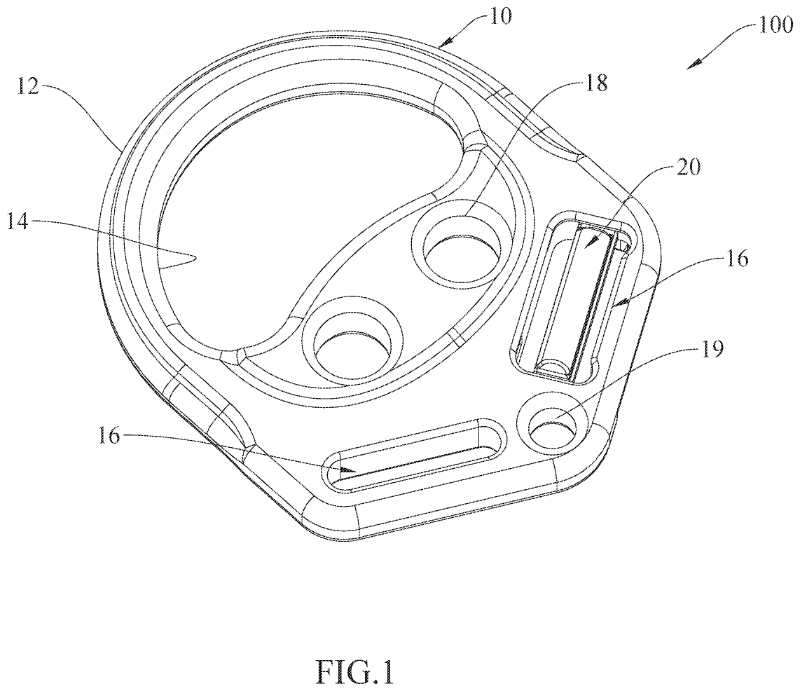

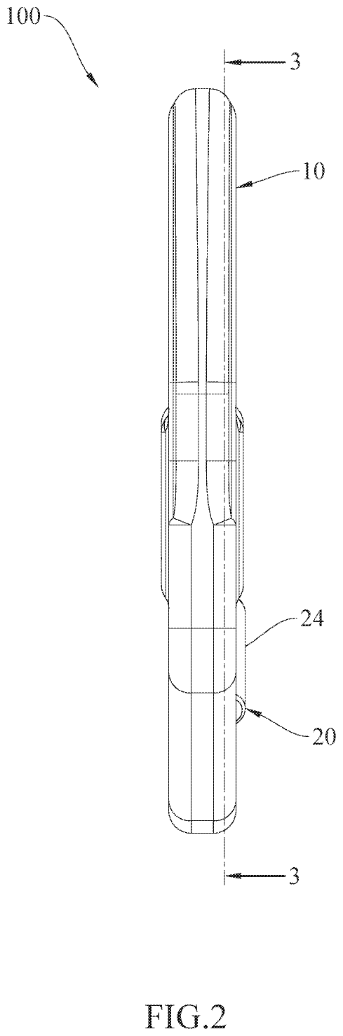

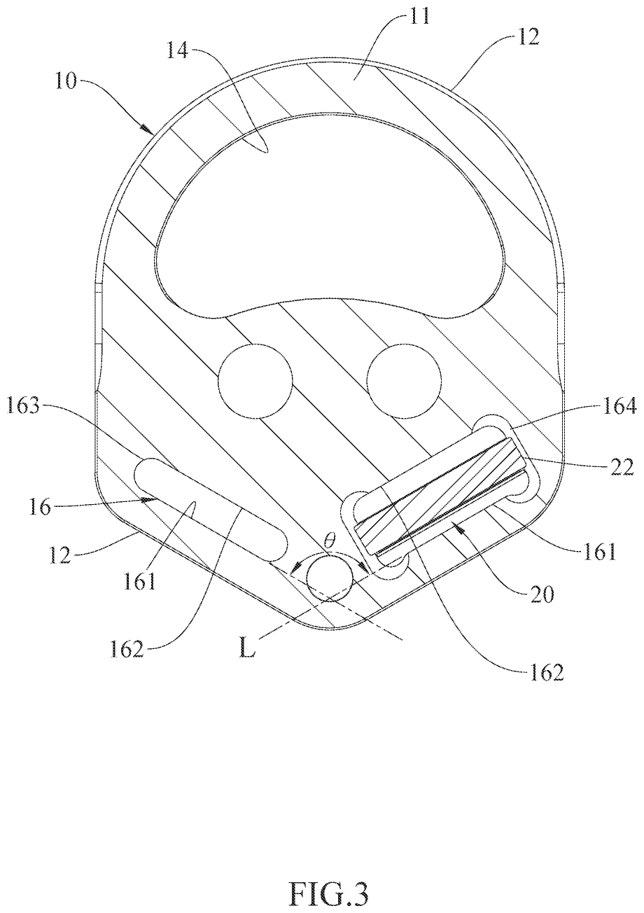

A multifunctional connector ring 100 according to an embodiment of the present invention is illustrated in FIG. 1 to FIG. 3 and includes a ring body 10 and a sliding rod 20. The ring body 10 is a metal plate and has a periphery 12 at a circumference of the ring body 10. The ring body 10 has a hanging hole 14, two webbing holes 16, and two rope holes 18. The two rope holes 18 are located between the hanging hole 14 and the two webbing holes 16. The ring body 10 further has a third rope hole 19, wherein the third rope hole 19 is located between the two webbing holes 16.

A hanging rod 11 is formed by a part of the ring body 10 located between the periphery 12 and the hanging hole 14. The two rope holes 18 are two perforations which are the same size and disposed side by side. Each of the two webbing holes 16 is a long hole and has a first long edge 161, a second long edge 162 opposite to the first long edge 161, and two short edges 163 connected between the first long edge 161 and the second long edge 162. The first long edge 161 of each of the two webbing holes 16 is close to the periphery 12 of the ring body 10, and the second long edge 162 is away from the periphery 12 of the ring body 10. In the embodiment, a part of the periphery 12 close to each of the two first long edges 161 is parallel to each of the two first long edges 161; an angle θ formed by two extension lines L of the two first long edges 161 of the two webbing holes 16 ranges from 90 degrees to 180 degrees; more specifically, the angle θ is 120 degrees.

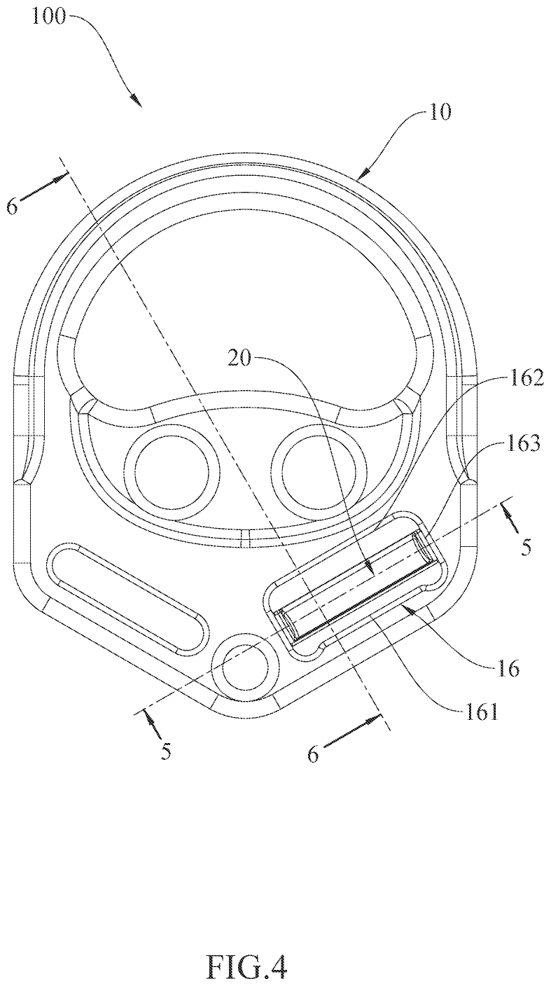

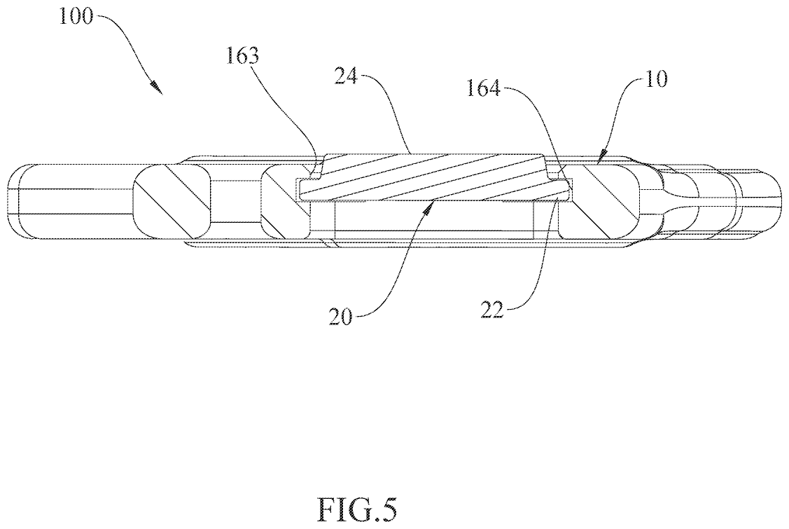

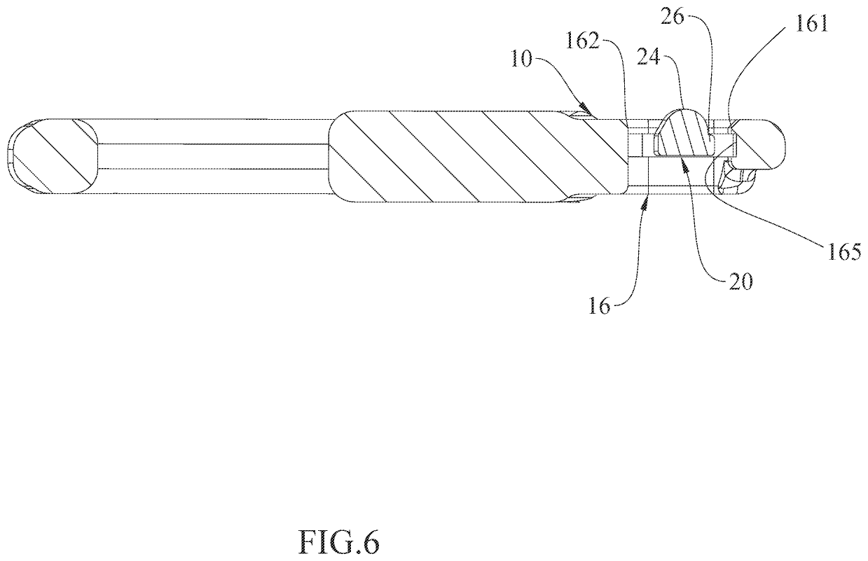

As illustrated in FIG. 4 to FIG. 6, the two short edges 163 of one of the two webbing holes 16 have a sliding groove 164 respectively. The sliding rod 20 is a straight rod body and has two end portions 22, wherein the two end portions 22 are respectively inserted into the two sliding grooves 164, so that the sliding rod 20 is slidable toward the first long edge 161 of the webbing hole 16, which is provided with the two sliding grooves 164, along the two sliding grooves 164 or toward the second long edge 162 of the webbing hole 16, which is provided with the two sliding grooves 164, along the two sliding grooves 164. A middle of the sliding rod 20 has a protrusion 24, wherein a surface of the protrusion 24 is a curved surface and protrudes out of a surface of the webbing hole 16, which is provided with the two sliding grooves 164. The webbing hole 16, which is provided with the sliding rod 20, forms a recessed groove 165 on the first long edge 161 of the webbing hole 16. The sliding rod 20 has a protruding rib 26 matching with the recessed groove 165. The protruding rib 26 and the recessed groove 165 match with each other in a concave-convex manner. When the sliding rod 20 slides toward the first long edge 161 of the webbing hole 16 along the two sliding grooves 164, the protruding rib 26 could fit in the recessed groove 165.

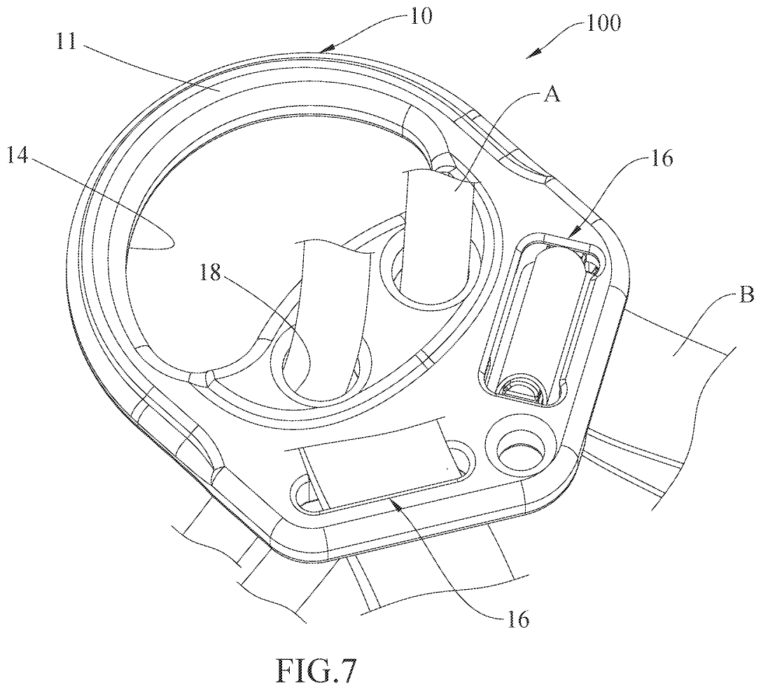

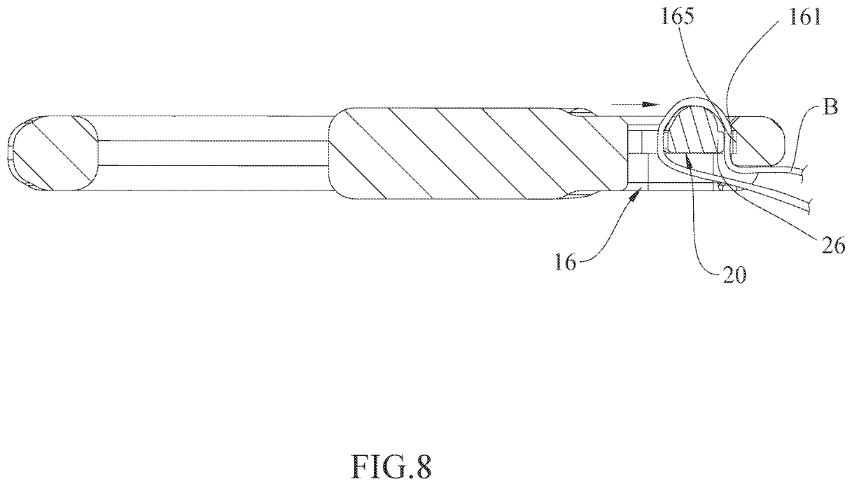

As illustrated in FIG. 1, FIG. 7, and FIG. 8, when the multifunctional connector ring 100 of the embodiment is used, the hanging rod 11 of the ring body 10 is adapted to hang a hook or an accessory; each of the two rope holes 18 or the third rope hole 19 could be passed by a rope A; each of the two webbing holes 16 is passed by a webbing B; in this way, the connector ring 100 provides a multifunctional effect of hooking, handing the accessory, being passed by ropes and webbings. In addition, after a free end of the webbing B passes between the sliding rod 20 and the second long edge 162 of the webbing hole 16 provided with the sliding rod 20, the webbing B is folded backward along the protrusion 24 of the sliding rod 20 and the free end of the webbing B reversely passes between the sliding rod 20 and the first long edge 161 of the webbing hole 16; then the free end of the webbing B is tightly pulled outward and the webbing B surrounds the sliding rod 20 and is pulled toward the first long edge 161 of the webbing hole 16, so that the sliding rod 20 is moved toward the first long edge 161 of the webbing hole 16. By the recessed groove 165 working with the protruding rib 26, the webbing B passing between the sliding rod 20 and the first long edge 161 of the webbing hole 16 is tightly clamped, so that a length of the webbing B passing through the webbing hole 16 is fixed, thereby achieving an effect fixing the length of the webbing B without requiring another fastener and being convenient for users to utilize.

It must be pointed out that the embodiments described above are only some preferred embodiments of the present invention. All equivalent structures which employ the concepts disclosed in this specification and the appended claims should fall within the scope of the present invention.

What is claimed is:

1. A multifunctional connector ring, comprising a ring body and a sliding rod, wherein the ring body has a hanging hole, two webbing holes, and two rope holes; the two rope holes are located between the hanging hole and the two webbing holes;
wherein a periphery of each of the two webbing holes has a first long edge, a second long edge, and two short edges connected between the first long edge and the second long edge; the two short edges of one of the two webbing holes have a sliding groove respectively; the sliding rod has two end portions, wherein the two end portions are respectively inserted into the two sliding grooves, so that the sliding rod is slidable toward the first long edge of the webbing hole provided with the two sliding grooves or toward the second long edge of the webbing hole provided with the two sliding grooves.

2. The multifunctional connector ring as claimed in claim 1, wherein the ring body has a periphery; the first long edge of each of the two webbing holes is close to the periphery of the ring body; the second long edge of each of the two webbing holes is away from the periphery of the ring body; the first long edge of the webbing hole that is provided with the two sliding grooves has a recessed groove; the sliding rod has a protruding rib; the protruding rib and the recessed groove match with each other in a concave-convex manner.

3. The multifunctional connector ring as claimed in claim 2, wherein a middle of the sliding rod has a protrusion; a surface of the protrusion is a curved surface and protrudes out of the webbing hole that is provided with the two sliding grooves.

4. The multifunctional connector ring as claimed in claim 3, wherein an angle formed by two extension lines of the two first long edges of the two webbing holes ranges from 90 degrees to 180 degrees.

5. The multifunctional connector ring as claimed in claim 2, wherein a part of the ring body located between the periphery of the ring body and the hanging hole forms a hanging rod.

6. The multifunctional connector ring as claimed in claim 3, wherein a part of the periphery of the ring body is parallel to the first long edge of each of the two webbing holes; the two rope holes are two perforations which are the same size and disposed side by side.

7. The multifunctional connector ring as claimed in claim 6, wherein the ring body has a third rope hole; the third rope hole is located between the two webbing holes.
